(19) United States
(12) Patent Application Publication
(10) Pub. No.: US 2013/0077858 A1
(43) Pub. Date: Mar. 28, 2013

(54) IMAGE PROCESSING MODULE AND IMAGE PROCESSING METHOD

(71) Applicants: Yuan-Chih PENG, Tainan City (TW); Yi-Lin TSAI, Tainan City (TW)

(72) Inventors: Yuan-Chih PENG, Tainan City (TW); Yi-Lin TSAI, Tainan City (TW)

(73) Assignee: HIMAX IMAGING LIMITED, Tainan City (TW)

(21) Appl. No.: 13/240,935

(22) Filed: Sep. 22, 2011

(51) Int. Cl. G06K 9/00

(52) U.S. Cl. 382/162

(57) ABSTRACT

An image processing module is provided. A de-mosaic unit in the image processing module includes an edge direction detection unit and a multi-pixel directional interpolation unit. The edge direction detection unit is used to determine an edge direction of a central pixel of the pixel array. The multi-pixels directional interpolation unit is used to determine at least one missing color value of the central pixel based on the edge direction, and determine at least one missing color value of the neighboring pixels based on the edge direction. An image enhancement unit in the image processing module is connected to the de-mosaic unit.

### BACKGROUND OF THE INVENTION

1. Field of the Invention

The present disclosure relates to an image processing module and an image processing method.

2. Description of the Related Art

An image sensor includes a photodiode array to transform incident light into electrical signals, which represent luminance of the incident light. In order to output a color image, the photodiode array is covered by a color filter array, which is for example arranged in Bayer pattern, and a single pixel can obtain only a single color value, referred to as an original color value. The Bayer pattern includes red-green rows and green-blue rows alternatively arranged. A bayer pattern image, with pixels each having only one color value of the three red, green and blue colors, is outputed as the raw data. Thus, for obtaining a complete color image, the raw data have to be processed by a de-mosaic process (color interpolation) to recover the other two missing color values of a corresponding pixel, based on the color value of the corresponding pixel and the color values of its neighbor pixels.

A conventional image processing device is shown as in FIG. 1. The image processing device 100 includes line buffers 110, de-mosaic unit 120, line buffers 130 for storing color space data such as RGB/YcbCr (de-mosaicked data), and image enhancement unit 140. For one example, the line buffers 110 can store raw data of four lines, in addition to one current line, so that the de-masic unit 120 has to process 5*5 array data one by one. The line buffers 130 for storing color space data can store, for example, three 3*3 array data one time such as a 3*3 red pixel array, a 3*3 green pixel array and a 3*3 blue pixel array.

The de-mosaic unit 120 includes an edge direction detection unit 122 and a directional interpolation unit 124, which are respectively used to perform edge direction detection and directional interpolation on an array of raw data shown in FIG. 2, the edge direction detection unit 122 uses the following formula (1), for example, to determine the edge direction of the central pixel b4:

diffV=|b4−b1|+|b4−b7|

diffH=|b4−b3|+|b4−b5| (1)

The directional interpolation unit 124 determines the missing color value, such as green color value in this example, at the central pixel b4 based on the edge direction, shown as the following formula (2):

if(diffV>diffH)g@b4=(g5+g6)/2

else

g@b4=(g3+g8)/2 (2)

The term diffV represents a vertical variation corresponding to the central pixel b4, which is a vertical difference between the central pixel b4 and its neighbor pixels, b1 and b7, of the same color in the same column (vertical direction). The term diffH represents a horizontal variation corresponding to the central pixel b4, which is a horizontal difference between the central pixel b4 and it neighbor pixels b3 and b5 of the same color in the same row (horizontal direction). The edge direction of the central pixel b4 is regarded as horizontal if the value of diffV is larger than the value of diffH. Otherwise, the edge direction of the central pixel is at a vertical edge if the value of diffV is less than the value of diffH

The pixels b0-b8 represent blue pixels having blue color values, the pixels g0-g11 represent the green pixels having green color values, and g@b4 represents the interpolated green color value at the pixel b4. The formula (2) can determine the interpolated color value of green corresponding to the pixel b4.

However, the conventional de-mosaic unit 120 requires many lines buffers to store the interpolated color values for further processing by the image enhancement unit 140, and therefore occupies a significant area of the sensor IC. .

### BRIEF SUMMARY OF INVENTION

A detailed description is given in the following embodiments with reference to the accompanying drawings.

In one embodiment, the invention provides an image processing module. The image processing module comprises a de-mosaic unit including an edge direction detection unit and a multi-pixel directional interpolation unit, and an image enhancement unit. The edge direction detection unit is used to determine an edge direction of a central pixel of the pixel array. The multi-pixel directional interpolation unit is used to determine at least one missing color value of the central pixel based on the edge direction, and determine at least one missing color value of the neighboring pixels based on the edge direction. The image enhancement unit is connected to the de-mosaic unit.

In one embodiment, the invention provides an image processing method. The image processing method comprises: receiving raw data of a pixel array; and de-mosaicking the raw data, the de-mosaic step comprising: determining an edge direction of a central pixel of the pixel array; determining at least one missing color value of the central pixel based on the edge direction; and determining at least one missing color value of the neighboring pixels based on the edge direction for outputting a full-color image.

Because the image processing module and the image processing method in the embodiment may calculate pixel color values of a 3*3 array simultaneously, the advantages for reducing cost and raising operation speed are achieved without extra line buffers for storing color interpolated data.

### BRIEF DESCRIPTION OF DRAWINGS

The present invention can be more fully understood by reading the subsequent detailed description and examples with references made to the accompanying drawings, wherein:

FIG. 1 is a diagram showing a conventional image processing device;

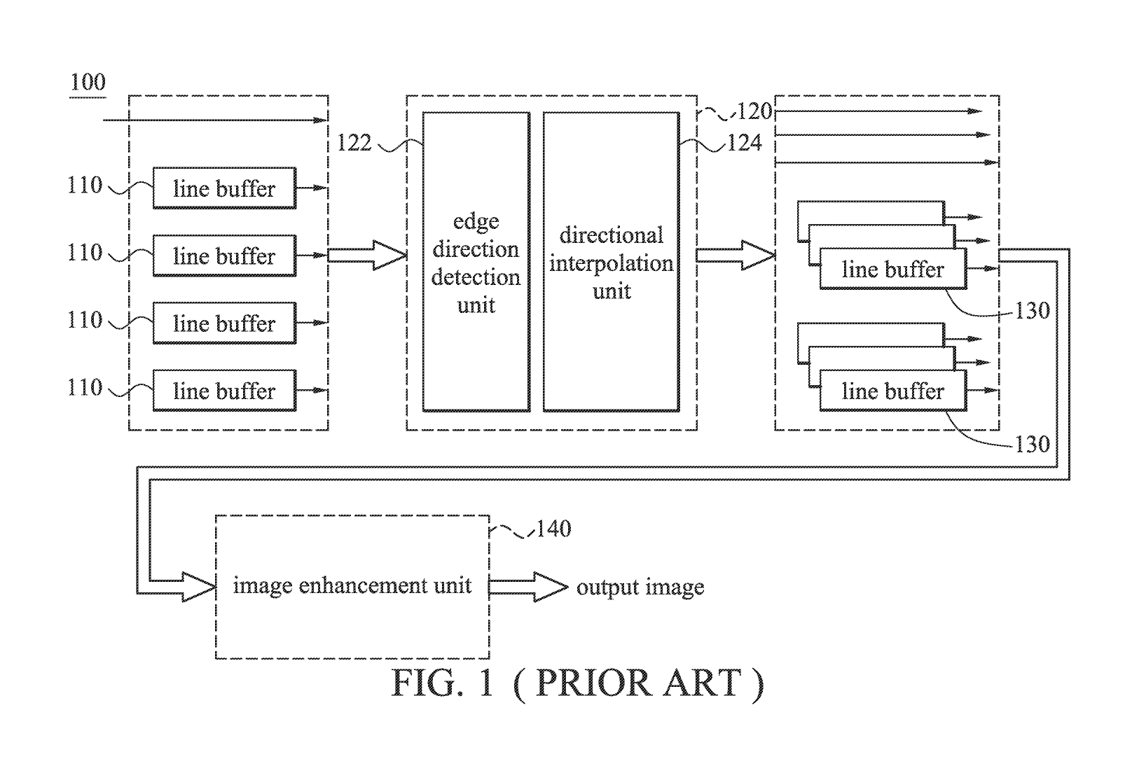

FIG. 2 is a diagram showing a 5*5 array in Bayer pattern;

FIG. 3 is a diagram showing an image processing device according to the embodiment of the invention; and

FIG. 4 is a flowchart illustrating the image processing method according to the embodiment of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

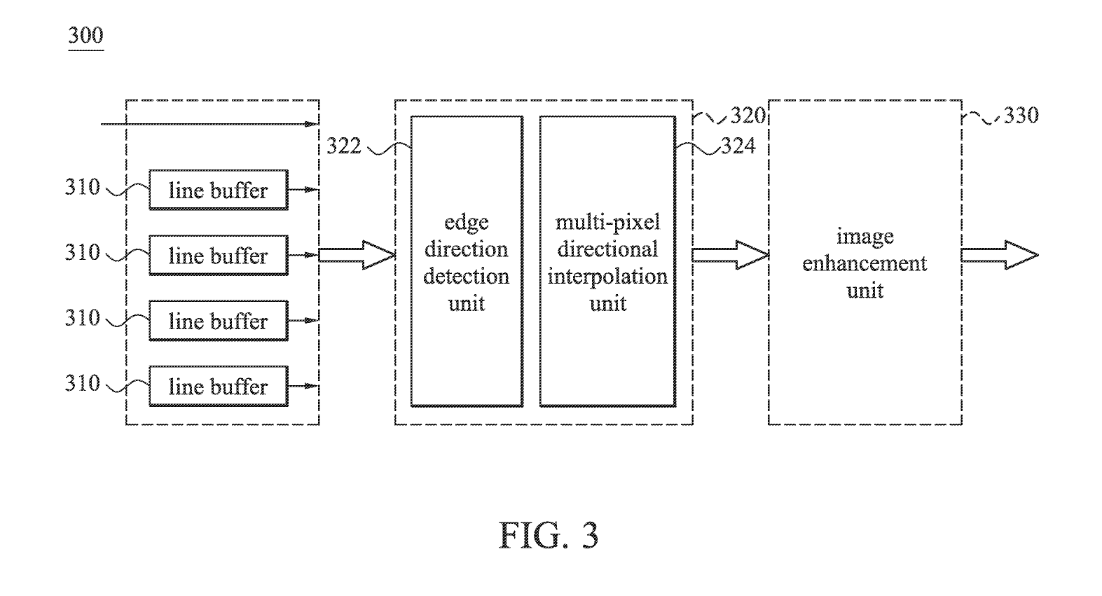

FIG. 3 is a diagram showing an image processing device according to the embodiment of the invention. The image processing device 300 includes line buffers 310, a de-mosaic unit 320 and an image enhancement unit 330. The de-mosaic unit 320 includes an edge direction detection unit 322 and a multi-pixel directional interpolation unit 324. The image enhancement unit 330 may include, for example, a noise reduction unit (not shown) for processing image noise and a sharpness enhancement unit (not shown) for performing image sharpness.

The line buffers 310 are used to store raw data of, for example, pixels of four lines in addition to one current line. The de-mosaic unit 320 receives raw data of an pixel array, 5×5 in this embodiment, to generate missed color values for each pixel. The raw data come from a sensor with a color filter array arranged in , for example, Bayer pattern and include original color values respectively for pixels of the image. The image enhancement unit 330 is used to enhance image quality, such as noise reduction and sharpness.

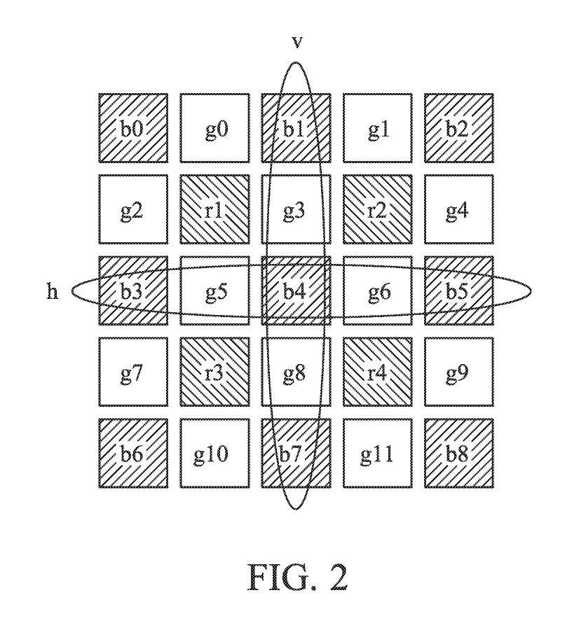

First, the edge direction detection unit 322 determines a vertical variance of first color according to a plurality of first color pixels in a pixel column of the raw data. The vertical variance of first color is for example a sum of the absolute difference of color values between the central pixel of the pixel column and other pixels else at the same column. For example, referring to FIG. 2, in the embodiment, the first color is blue and regard to the pixels in the third column, the third column includes pixel b1, b4, b7, g3, g8. The vertical variance diffV corresponding to the central pixel b4 is expressed as following equation:

diffV=|b4−b1|+|b4−b7|

Second, the edge direction detection unit 322 determines a horizontal variance of first color according to a plurality of first color pixels in a pixel row of the raw data. The horizontal variance of first color is a sum of the absolute difference of the color values between the central pixel of the pixel row and other pixels else at the same row. For example, referring to FIG. 2, in the embodiment, the first color is blue and, regard to the pixels in the third row, the third row includes pixel b3-b5 and pixels g5-g6. The horizontal difference corresponding to the central pixel b4 are expressed as following equation:

diffH=|b4−b3|+|b4−b5

If the vertical variance diffV is larger than the horizontal variance diffH, the edge direction of the central pixel b4 is determined to be horizontal; if the vertical variance diffV is less than the horizontal variance diffH, the edge direction of the central pixel b4 is determined to be vertical. In addition, the edge direction detection unit 322 applies this detected direction of the central pixel b4 to the neighboring pixels for the multi-pixel directional interpolation unit 324, that is, the directions of the neighboring pixels are supposed to be the same as that of the central pixel b4.

After the edge direction of the central pixel b4 is determined by the edge direction detection unit 322, then the multi-pixel directional interpolation unit 324 is used to determine the missing color values of the central pixel b4 and missing color values of its neighboring pixels according to the edge direction. For example, in the embodiment, the first color is blue, the second color is red, and the third color is green. The missing green color value for each corresponding pixel is determined according to the detected edge direction, specifically, the missing green color value is an average of two color values of two green pixels along the detected edge direction and adjacent to the corresponding pixel.

The above method may be expressed as following formula:

if (diffV>diffH)g@b4=(g5+g6)/2

g@r1=(g2+g3)/2

g@r2=(g3+g4)/2

g@r3=(g7+g8)/2

g@r4=(g8+g9)/2

else

g@b4=(g3+g8)/2

g@r1=(g0+g5)/2

g@r2=(g1+g6)/2

g@r3=(g5+g10)/2

g@r4=(g6+g11)/2

The above formula outputs the missing green color values of red and blue pixels of the pixel array based on the same edge direction. The missing blue color values and the missing red color values can be obtained by similar method or by other different methods. The interpolated color values for each pixel are then output to the image enhancement unit 330 for further processing. Since the interpolated color values can be generated based on values stored in the four line buffers 310 and one current line, no buffer is needed for the storage of the interpolated color values.

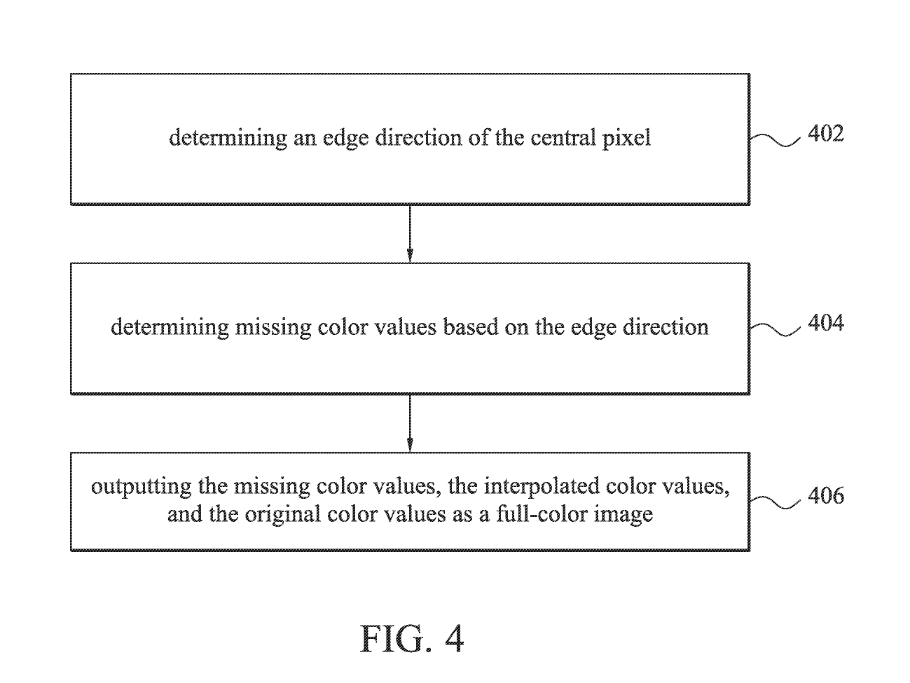

FIG. 4 is a flowchart illustrating the image processing method according to the embodiment of the invention. In step 402, the edge direction detection unit determines an edge direction of the central pixel based on the vertical variance and horizontal variance. The vertical variance diffV corresponding to the central pixel b4 is expressed as following equation:

diffV=|b4−b1|+|b4−b7|

The horizontal variance diffH corresponding to the central pixel b4 is expressed as following equation:

diffH=|b4−b3|+|b4−b5|

The edge direction of central pixel b4 is thus determined based on at least the vertical variance diffV and the horizontal variance diffH. It should be noted that this embodiment uses only vertical variance and horizontal variance to determine the edge direction, but diagonal variance can also be considered in other embodiments.

In step 404, the multi-pixel directional interpolation unit 324 is used to determine missing color values of the central pixel b4 and missing color values of its neighboring pixels according to the edge direction. In this embodiment, the missing green color value for each corresponding pixel is determined by interpolation along the detected edge direction. The missing blue color values and the missing red color values can be obtained by similar method or by other different methods.

In step 406, the missing color values, the interpolated color values, and the original color values are then output as a full-color image to the image enhancement unit 330 for further processing.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image processing module, comprising:
a de-mosaic unit, for de-mosaicking raw data of a pixel array, the de-mosaic module comprises:
an edge direction detection unit, for determining an edge direction of a central pixel of the pixel array; and
a multi-pixel directional interpolation unit, for determining at least one missing color value of the central pixel based on the edge direction, and determining at least one missing color value of the neighboring pixels based on the edge direction; and
an image enhancement unit, connected to the de-mosaic unit.

2. The image processing module as claimed in claim 1, wherein the edge direction unit first determines a vertical variance and a horizontal variance corresponding to the central pixel, and then determines the edge direction to be horizontal if the vertical variance is larger than the horizontal variance, and determines the edge direction to be vertical if the horizontal variance is larger than the vertical variance.

3. The image processing module as claimed in claim 1, wherein the missing color value of the central pixel and the missing color value of the neighboring pixels correspond to a same color.

4. The image processing module as claimed in claim 1, wherein the same color is green.

5. The image processing module as claimed in claim 3, wherein the multi-pixel directional interpolation unit determines a plurality of the missing color values, respectively, for the neighboring pixels.

6. The image processing module as claimed in claim 1, wherein the multi-pixel directional interpolation unit determines missing color value of the central pixel and the missing color value of the neighboring pixels by interpolation along the edge

7. The image processing module as claimed in claim 1, wherein the pixel array is covered with a color filter array arranged in Bayer pattern.

8. An image processing method, comprising:
receiving raw data of a pixel array; and
de-mosaicking the raw data, the de-mosaic step comprising:
determining an edge direction of a central pixel of the pixel array;
determining at least one missing color value of the central pixel based on the edge direction; and
determining at least one missing color value of the neighboring pixels based on the edge direction for outputting a full-color image.

9. The image processing method as claimed in claim 7, wherein the edge direction determining step first determines a vertical variance and a horizontal variance corresponding to the central pixel, and then determines the edge direction to be horizontal if the vertical variance is larger than the horizontal variance, and determines the edge direction to be vertical if the horizontal variance is larger than the vertical variance.

10. The image processing method as claimed in claim 8, wherein the missing color value of the central pixel and the missing color value of the neighboring pixels correspond to a same color.

11. The image processing method as claimed in claim 8, wherein the same color is green.

12. The image processing method as claimed in claim 8, wherein the missing color determining step determines a plurality of the missing color values, respectively, for the neighboring pixels.

13. The image processing module as claimed in claim 8, wherein the missing color determining step determines missing color value of the central pixel and the missing color value of the neighboring pixels by interpolation along the edge direction.
